(19) United States
(12) Patent Application Publication
(10) Pub. No.: US 2016/0341108 A1
(43) Pub. Date: Nov. 24, 2016

(54) INTERNAL COMBUSTION ENGINE

(71) Applicant: TOYOTA JIDOSHA KABUSHIKI KAISHA, Toyota-shi (JP)

(72) Inventors: Shintaro UTSUMI, Susono-shi (JP); Kohei KODAMA, Numazu-shi (JP); Hiroki MURATA, Gotenba-shi (JP)

(73) Assignee: TOYOTA JIDOSHA KABUSHIKI KAISHA, Toyota-shi (JP)

(21) Appl. No.: 15/155,163

(22) Filed: May 16, 2016

(30) Foreign Application Priority Data
May 20, 2015 (JP) 2015-102630

(51) Int. Cl. F02B 31/08; F02M 26/13; F02M 26/20; F02D 41/00; F01P 5/10; F01P 3/02; F01P 5/12

(52) U.S. Cl. CPC F02B 31/08; F01P 3/02; F02M 26/13; F01P 5/12; F02D 41/0002; F01P 5/10; F02M 26/20; F01P 2005/125; F01P 2005/105; F01P 2003/021; F01P 2003/024

(57) ABSTRACT

An internal combustion engine includes: a low-temperature cooling water circulation system including a low-temperature cooling water channel; a high-temperature cooling water circulation system including a high-temperature cooling water channel; an intake port including a first branch port part and a second branch port part that are connected to a common combustion chamber; and a swirl control device configured to restrict the inflow of intake air from the first branch port part to the combustion chamber to increase the strength of a swirl flow generated inside a cylinder. The low-temperature cooling water channel includes a water jacket that covers the periphery of the second branch port part.

### BACKGROUND

1. Technical Field

Embodiments of the present invention relate to an internal combustion engine, and more particularly to an internal combustion engine which includes a cylinder head having a flow channel where cooling water flows, and in which a swirl flow is generated inside a cylinder.

2. Background Art

Flow channels through which cooling water flow are formed in a cylinder head of an internal combustion engine. Patent Document 1 mentioned below discloses a configuration in which, in order to adequately cool air inside an intake port, a first cooling water circuit through which cooling water for cooling the periphery of the intake port inside a cylinder head circulates is provided independently from a second cooling water circuit through which cooling water for cooling a cylinder block and the periphery of an exhaust port inside the cylinder head circulates.

### LIST OF RELATED ART

Following is a list of patent documents including the above described one which the applicant has noticed as related arts of the present invention.

### Patent Document 1

Japanese Patent Laid-Open No. 2013-133746

### TECHNICAL PROBLEM

An internal combustion engine is known that includes an intake port having a first branch port part and a second branch port part that are connected to a common combustion chamber, and a swirl control device that is configured to restrict the inflow of intake air into the combustion chamber from the first branch port part to increase the strength of a swirl flow generated inside a cylinder. If the inflow of intake air to the combustion chamber from the first branch port part is restricted by the swirl control device, when viewed at a cross-section that is perpendicular to the central trajectory of the intake port, a region arises at which the intake air flow rate relatively decreases inside the intake port. Further, in an example where the aforementioned restriction of the inflow of intake air is of a form that stops the inflow of intake air, when viewed at the aforementioned cross-section, a region through which intake air does not flow may arise inside the intake port. Intake air is liable to stagnate at such a region.

Intake air that flows through an intake port may include evaporated fuel, blow-by gas and EGR gas or the like that flows in from upstream. Further, unburned gas and in-cylinder residual gas (burned gas) are included in intake air that is blown back to the intake port from inside the cylinder when an intake valve opens and closes. Consequently, if the intake port is cooled without giving particular consideration to such cooling, matter contained in the gas that stagnates inside the intake port is liable to be deposited on a wall surface of the intake port.

### SUMMARY

Embodiments of the present invention address the above-described problem and have an object to provide an internal combustion engine that is configured to suppress deposition of matter contained in the intake air on a wall surface of an intake port, while receiving the advantages (for example, suppression of knocking) obtained by cooling intake air at the time of strengthening a swirl flow.

An internal combustion engine according to embodiments includes: a low-temperature cooling water circulation system that is one of two cooling water circulation systems in which temperatures of cooling water are different, and that includes a low-temperature cooling water channel formed in an internal combustion engine, and that is configured to causes cooling water of a low temperature to circulate in the low-temperature cooling water channel; a high-temperature cooling water circulation system that is one of the two cooling water circulation systems, and that includes a high-temperature cooling water channel formed in the internal combustion engine, and that configured to cause cooling water of a high temperature to circulate in the high-temperature cooling water channel; an intake port including a first branch port part and a second branch port part that are connected to a common combustion chamber; and a swirl control device configured to restrict an inflow of intake air from the first branch port part to the combustion chamber to increase a strength a swirl flow generated inside a cylinder. The low-temperature cooling water channel includes a water jacket that is arranged so as to cover a part of a periphery of the intake port when the intake port is viewed at a cross section that is perpendicular to a central trajectory of the intake port. The water jacket is arranged so that, when the intake port is viewed at the cross section, the water jacket covers a periphery of a region in which an intake air flow rate inside the intake port becomes relatively larger when an inflow of intake air to the combustion chamber from the first branch port part is restricted by the swirl control device.

The internal combustion engine may include an exhaust gas recirculation passage through which recirculated exhaust gas that returns from an exhaust passage to an intake passage flows. The swirl control device may include a swirl control valve that is configured to open and close an intake air flow channel inside the first branch port part. The exhaust gas recirculation passage may be connected to the first branch port part on a downstream side of the swirl control valve.

The internal combustion engine may include a blow-by gas return passage through which blow-by gas that returns to an intake passage flows. The swirl control device may include a swirl control valve that is configured to open and close an intake air flow channel inside the first branch port part. The blow-by gas return passage may be connected to the first branch port part on a downstream side of the swirl control valve.

The water jacket may be formed so as to cover a periphery of the second branch port part.

According to embodiments of the present invention, when an intake port is viewed at a cross-section that is perpendicular to a central trajectory of the intake port, a water jacket for cooling intake air is provided with respect to a region at which the intake air flow rate becomes relatively large inside the intake port when an inflow of intake air from a first branch port part to a combustion chamber is restricted by a swirl control device. It is thereby possible to make it difficult for intake air that may include blow-by gas or the like to be cooled in a region in which the intake air flow rate becomes relatively small or in a region in which intake air does not flow due to the aforementioned restriction of the inflow of intake air, that is, a region in which intake air is liable to stagnate. Consequently, the deposition of matter on a wall surface of the intake port can be suppressed.

### BRIEF DESCRIPTION OF THE DRAWINGS

FIG. 1 is a schematic diagram illustrating the system configuration of an engine according to the first embodiment of the present application;

FIG. 2 is a cross-sectional diagram of a cylinder head that is cut along a line A-A shown in FIG. 1;

FIG. 3 is a perspective view in which intake ports and a first LT cooling water channel shown in FIG. 1 are illustrated in a transparent manner from above the intake side;

FIG. 4 is a perspective view in which the intake ports and the first LT cooling water channel shown in FIG. 1 are illustrated in a transparent manner from the upstream side of the flow of intake air inside branch port parts of the intake ports;

FIG. 5 is a schematic view illustrating the configuration around the intake port according to the first embodiment;

FIG. 6 is a schematic view for describing the configuration around the intake port according to the second embodiment of the present application;

FIG. 7 is a perspective view that schematically illustrates another configuration example of an SCV in the present application; and

FIG. 8 is a view for describing a region in which a water jacket that covers a periphery of the intake port in the engine shown in FIG. 7 is arranged.

### DETAILED DESCRIPTION

Embodiments will now be described referring to the accompanying drawings.

However, the embodiments described hereunder exemplify an apparatus or a method for materializing the technical concept of the present application, and except where otherwise expressly stated, it is not intended to limit the structures and arrangements of the constituent components and the order of processes and the like to those described hereunder. The present application is not limited to the embodiments described hereunder, and various modifications can be made within a range that does not depart from the gist of the present application.

### First Embodiment

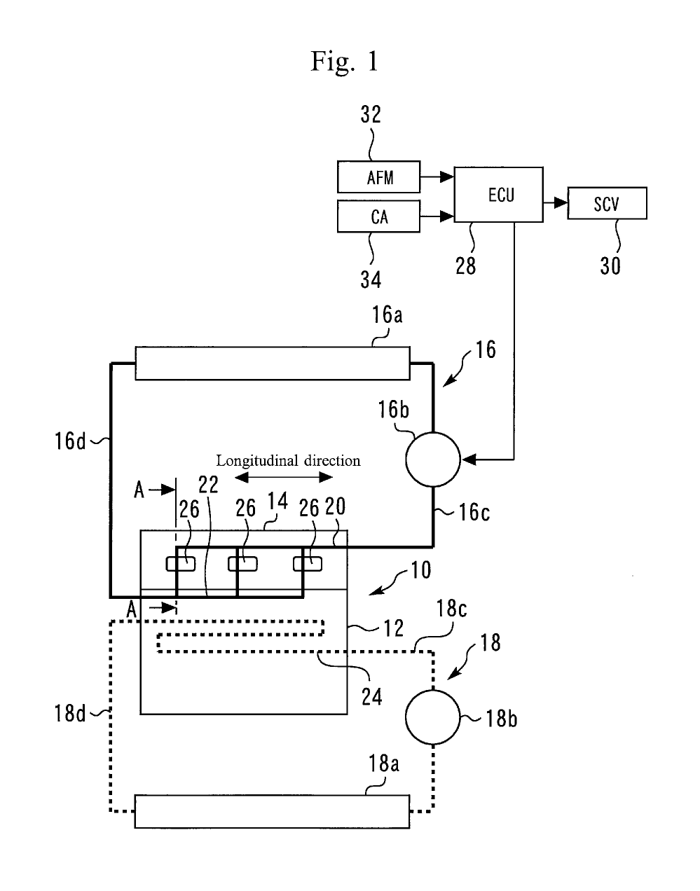

Hereunder, a first embodiment of the present application is described using FIG. 1 to FIG. 5. The description of the first embodiment is based on the premise that the internal combustion engine (hereunder, abbreviated as “engine”) is a spark-ignition type, water-cooled inline three-cylinder engine. This premise also applies to a second embodiment and the like that are described later. However, the number of cylinders, the layout of cylinders, and the type of ignition of an engine according to the present application is not particularly limited. Further, cooling water for cooling the engine is circulated between the engine and a radiator by a circulation system. Cooling water is supplied to both of the cylinder block and the cylinder head.

### [System Configuration of Engine]

The system configuration of an engine 10 according to the first embodiment of the present application will be described referring to FIG. 1. The engine (internal combustion engine) 10 shown in FIG. 1 includes a cylinder block 12, and a cylinder head 14 that is mounted on the cylinder block 12 via an unshown gasket.

An engine cooling system of the first embodiment includes two cooling water circulation systems 16 and 18. Each of the two cooling water circulation systems 16 and 18 is an independent closed loop, and the temperatures of the cooling water circulated through the respective circulation systems can be made to differ from each other. Hereunder, the cooling water circulation system 16 in which cooling water of a relatively low temperature circulates is referred to as an “LT cooling water circulation system”, and the cooling water circulation system 18 in which cooling water of a relatively high temperature circulates is referred to as an “HT cooling water circulation system”. The HT cooling water circulation system 18 is responsible for the principal cooling of the cylinder block 12. On the other hand, the LT cooling water circulation system 16 is mainly responsible for cooling of an intake port 26 for which a cooling load is small in comparison to the cylinder block 12. Note that, “LT” is an abbreviation of “low temperature” and “HT” is an abbreviation of “high temperature”. Further, the engine cooling system may include an unshown water temperature sensor or a thermostat for regulating the water temperature.

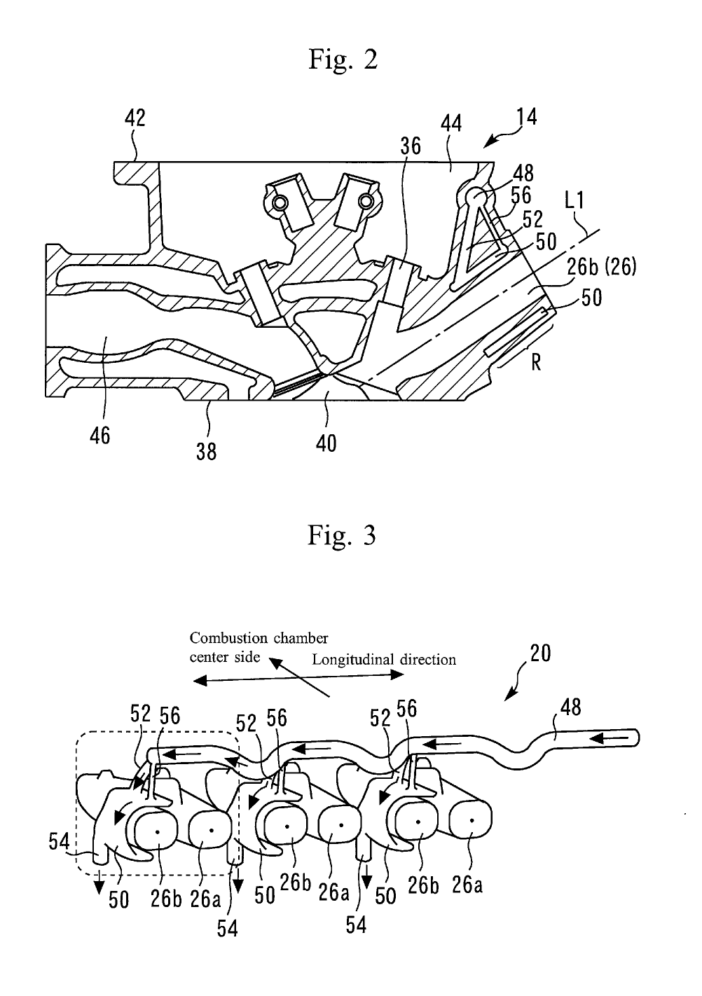

The LT cooling water circulation system 16 includes a first LT cooling water channel 20 that is formed inside the cylinder head 14, and a second LT cooling water channel 22 that is formed inside the cylinder block 12. A cooling water inlet that communicates with the first LT cooling water channel 20 is formed in the cylinder head 14. The first LT cooling water channel 20 of the cylinder head 14 and the second LT cooling water channel 22 of the cylinder block 12 are connected through an opening formed in an abutting surface 38 (see FIG. 2) between the cylinder head 14 and the cylinder block 12. A cooling water outlet of the second LT cooling water channel 22 is formed in the cylinder block 12. The cooling water inlet of the cylinder head 14 is connected to a cooling water outlet of an LT radiator 16a via an LT cooling water introduction pipe 16c. A cooling water outlet of the cylinder block 12 is connected to a cooling water inlet of the LT radiator 16a via a cooling water discharge pipe 16d. An LT water pump 16b is provided in the LT cooling water introduction pipe 16c.

The HT cooling water circulation system 18 includes an HT cooling water channel 24 that is formed inside the cylinder block 12. The HT cooling water channel 24 of the cylinder block 12 includes a water jacket that covers a periphery of each cylinder. A cooling water inlet and a cooling water outlet that are connected to the HT cooling water channel 24 are also formed in the cylinder block 12. The cooling water inlet of the HT cooling water channel 24 is connected to a cooling water outlet of an HT radiator 18a via an HT cooling water introduction pipe 18c. The cooling water outlet of the HT cooling water channel 24 is connected to a cooling water inlet of the HT radiator 18 via an HT cooling water discharge pipe 18d. An HT water pump 18b is provided in the HT cooling water introduction pipe 18c.

An intake port 26 that is one part of an intake passage of the engine 10 is formed for each cylinder in the cylinder head 14. The arrangement of the first LT cooling water channel 20 around the intake port 26 will be described in detail later referring to FIGS. 2 to 5.

As one example, the LT water pump 16b is an electric motor-driven water pump. Further, as one example, the HT water pump 18b is a water pump that is driven by the torque of a crankshaft (not illustrated in the drawings). The LT water pump 16b is electrically connected to an electronic control unit (ECU) 28, and is driven in accordance with commands from the ECU 28. The ECU 28 includes at least an input/output interface, a memory and a central processing unit (CPU), and performs control of not only the above described cooling system, but also of the entire system of the engine 10.

Various actuators for controlling operation of the engine 10, such as an electric motor 64 (see FIG. 5) for rotationally driving a swirl control valve (SCV) 30 for controlling the strength of a swirl flow inside a cylinder are connected to the ECU 28. The SCV 30 is described in detail later referring to FIG. 5. In addition, various sensors for detecting the operating state of the engine 10, such as an air flow meter (AFM) 32 that measures an intake air flow rate, and a crank angle sensor (CA) 34 for acquiring the engine speed are connected to the ECU 28.

### [Internal Configuration of Cylinder Head]

FIG. 2 is a cross-sectional diagram of the cylinder head 14 that is cut along a line A-A shown in FIG. 1. In the present specification, as shown in FIG. 1, the axial direction of the crankshaft is defined as the longitudinal direction of the cylinder head 14. The A-A cross-section of the cylinder head 14 is a cross-section that includes a central axis of an intake valve insertion hole 36 of the cylinder head 14, and that is perpendicular to the longitudinal direction. Reference character L1 shown in FIG. 2 denotes a central trajectory of the intake port 26.

As shown in FIG. 2, a combustion chamber 40 having a pent-roof shape is formed in the cylinder block abutting surface 38 that corresponds to the underside of the cylinder head 14. When the cylinder head 14 is assembled to the cylinder block 12, the combustion chamber 40 blocks off the cylinder from the upper side to constitute a closed space. Note that, because the engine 10 is an inline three-cylinder engine, three combustion chambers 40 that correspond to three cylinders are formed side by side at even intervals in the longitudinal direction of the cylinder head 14.

The intake port 26 is open in one inclined face (roof) of the combustion chamber 40. The interfaces between the intake port 26 and the combustion chamber 40, that is, opening ends on the combustion chamber side (outlet side) of the intake port 26 are intake openings that are opened and closed by the respective intake valves 58 (see FIG. 5). Since two of the intake valves 58 are provided for each cylinder, two intake openings of the intake port 26 are formed in the combustion chamber 40. An inlet of the intake port 26 is open in one side face of the cylinder head 14.

A flow channel for intake air inside the intake port 26 branches into two parts at a position that is partway along the flow channel. Here, the branched parts of the intake port 26 are referred to as a “first branch port part 26a” and a “second branch port part 26b”. The first branch port part 26a and the second branch port part 26b are arranged side by side in the longitudinal direction of the cylinder head 14, and the branch port parts are connected to the respective intake opening formed in the common combustion chamber 40. The second branch port portion 26b is illustrated in FIG. 2.

An intake valve insertion hole 36 is formed in the cylinder head 14 to allow a stem of the intake valve 58 to pass through. An intake-side valve train chamber 44 that houses a valve train that actuates the intake valves 58 is provided on the inner side of a head cover mounting face 42 that is a part of the upper face of the cylinder head 14. Note that, an exhaust port 46 opens in another inclined face (roof) of the combustion chamber 40. The interfaces between the exhaust port 46 and the combustion chamber 40, that is, opening ends on the combustion chamber side of the exhaust port 46 are exhaust openings that are opened and closed by the respective exhaust valve 60 (see FIG. 5).

### [Configuration of LT Cooling Water Channel in Cylinder Head]

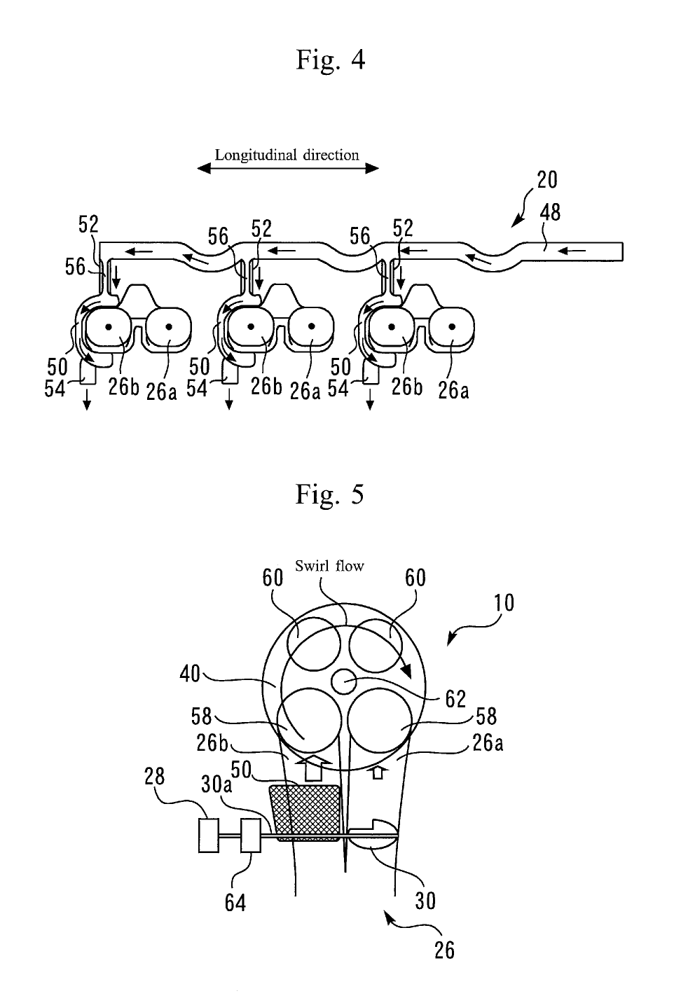

FIG. 3 is a perspective view in which the intake ports 26 and the first LT cooling water channel 20 shown in FIG. 1 are illustrated in a transparent manner from above the intake side. FIG. 4 is a perspective view in which the intake ports 26 and the first LT cooling water channel 20 shown in FIG. 1 are illustrated in a transparent manner from the upstream side of the flow of intake air inside the branch port parts 26a and 26b of the intake ports 26. In FIG. 3 and FIG. 4, the shape of the first LT cooling water channel 20 when the inside of the cylinder head 14 is viewed in a transparent manner, and the positional relation between the first LT cooling water channel 20 and the branch port parts 26a and 26b are illustrated. Note that, arrows in these diagrams represent the direction of the flow of cooling water.

The first LT cooling water channel 20 is configured to supply LT cooling water to the periphery of the second branch port part 26b of each cylinder in the cylinder head 14. More specifically, the first LT cooling water channel 20 includes a main flow channel 48. The main flow channel 48 extends in the direction of the row of intake ports 26 (that is, longitudinal direction of the cylinder head 14), at a position above the row of intake ports 26.

One end of the main flow channel 48 is open at a cooling water inlet of the cylinder head 14. Further, as shown in FIG. 2, the main flow channel 48 is provided so as to be located on the upper side of the intake ports 26 when it is assumed that the cylinder head 14 is positioned on the upper side in the vertical direction with respect to the cylinder block 12. That is, the main flow channel 48 is arranged at a location sufficiently separated from the cylinder block abutting surface 38. Consequently, reception of heat from the cylinder block abutting surface 38 by LT cooling water inside the main flow channel 48 is suppressed. This is preferable in terms of introducing low-temperature cooling water into a water jacket 50 of each intake port 26 from the main flow channel 48.

The first LT cooling water channel 20 has a unit structure for each intake port 26. In FIG. 3, the structure of a section surrounded by a dashed line is the unit structure of the first LT cooling water channel 20. The unit structure includes the water jacket 50 that is arranged at the periphery of the second branch port part 26b. Reference character R in FIG. 2 denotes a region in which the water jacket 50 is formed in a direction along the central trajectory L1 of the intake port 26 (flow channel extension direction). When the intake port 26 is viewed at a cross-section that is perpendicular to the central trajectory L1 of the intake port 26 (cross-section perpendicular to the flow channel extension direction of the intake port 26), inside the region R the water jacket 50 is formed so as to cover the periphery of the second branch port part 26b without covering the periphery of the first branch port part 26a.

Each water jacket 50 is connected to the main flow channel 48 through a branch flow channel 52. A connecting path 54 that communicates with the second LT cooling water channel 22 formed inside the cylinder block 12 is connected to each water jacket 50. That is, each water jacket 50 is open in the cylinder block abutting surface 38 through the corresponding connecting path 54.

Further, the first LT cooling water channel 20 includes an auxiliary flow channel 56 that connects the water jacket 50 and the main flow channel 48. The auxiliary flow channel 56 is a flow channel that serves a purpose as an air vent inside the water jacket 50, and is provided in a direction towards the main flow channel 48 from a top part in the vertical direction of the water jacket 50. Note that, the auxiliary flow channel 56 is configured as a flow channel in which the channel cross-sectional area is smaller than that of the branch flow channel 52.

According to the configuration illustrated in FIG. 3 and FIG. 4, LT cooling water that is cooled by the LT radiator 16a is introduced into the main flow channel 48. The LT cooling water introduced into the main flow channel 48 is guided in parallel to the water jackets 50 of the respective cylinders through the branch flow channels 52. The LT cooling water that is introduced to the respective water jackets 50 from the main flow channel 48 circulates along the periphery of the corresponding second branch port part 26b, and thereafter is discharged through the connecting path 54 to the second LT cooling water channel 22 of the cylinder block 12. According to the present configuration, the second branch port part 26b can be cooled by LT cooling water while ensuring that the first branch port part 26a is not cooled by the LT cooling water. That is, according to the present configuration, the intensity of cooling can be varied between the first branch port part 26a and the second branch port part 26b. Further, by cooling the wall surface of the second branch port part 26b by means of the LT cooling water, intake air that flows through the second branch port part 26b can be cooled.

[Configuration around Intake Port]

FIG. 5 is a schematic view illustrating the configuration around the intake port 26 according to the first embodiment. Note that, in FIG. 5, reference numeral 58 denotes an intake valve, reference numeral 60 denotes an exhaust valve, and reference numeral 62 denotes a spark plug.

The SCV 30 is arranged inside the first branch port part 26a. A rotary shaft 30a of the SCV 30 is connected to the electric motor 64. According to this configuration, the SCV 30 can be rotationally driven by means of the electric motor 64, and as a result an intake air flow channel inside the first branch port part 26a can be opened and closed. If the SCV 30 is closed, an inflow of intake air to the combustion chamber 40 from the first branch port part 26a is restricted. Consequently, a swirl flow that is generated inside the cylinder can be strengthened. The SCV 30 is controlled by the ECU 28 so as to close in an engine operating range in which it is necessary to strengthen the swirl flow, and to open in an engine operating range in which strengthening of the swirl flow is not necessary. Engine operating ranges can be identified by the engine torque and engine speed. Acquisition of the current engine operating point for determining a control position of the SCV 30 can be performed using, for example, an engine torque that is calculated based on an intake air flow rate that is measured by the air flow meter 32, and an engine speed that is calculated based on detection values of the crank angle sensor 34. Note that, if the SCV 30 is simply closed, the flow rate of air that flows into the cylinder will decrease. Therefore, when the SCV 30 is closed, an operation that opens a throttle valve (not illustrated in the drawings) for ensuring that the flow rate of air does not decrease is executed in a coordinated manner therewith.

According to one example that is illustrated in FIG. 5, the water jacket 50 is formed so as to cover the periphery of the second branch port part 26b. When the inflow of intake air from the first branch port part 26a to the combustion chamber 40 is restricted by closing the SCV 30, a deviation is generated between the respective intake air flow rates (mass flow rate) of the first branch port part 26a and the second branch port part 26b. More specifically, the deviation is generated in a form such that the intake air flow rate inside the first branch port part 26a becomes smaller in comparison to the intake air flow rate inside the second branch port part 26b. Accordingly, it can be said that the water jacket 50 for cooling intake air is not provided at the first branch port part 26a that corresponds to a region in which the intake air flow rate becomes relatively smaller when a deviation between the intake air flow rates within the intake port 26 is generated by means of the SCV 30, and the water jacket 50 is provided at the second branch port part 26b that corresponds to a region in which the intake air flow rate becomes relatively larger.

As described above, according to the configuration of the present embodiment, the water jacket 50 is provided for the second branch port part 26b on the side on which the inflow of intake air is not restricted when strengthening a swirl flow. Therefore, when the SCV 30 is closed and the swirl flow is strengthened, a large portion of the intake air that is introduced into the combustion chamber 40 can be cooled. This is favorable in an engine in which it is preferable to cool intake air in an engine operating range in which strengthening of a swirl is required.

In other words, in the present configuration, the water jacket 50 is not provided for the first branch port part 26a on the side on which an inflow of intake air is restricted when strengthening a swirl flow. Intake air that flows through an intake port may include evaporated fuel, blow-by gas or EGR gas and the like that flows in from upstream. According to the present configuration, it is possible to make it difficult to cool intake air that may include blow-by gas or the like, in a region in which the intake air is liable to stagnate as a result of the inflow of intake air being restricted. Therefore, the buildup of deposits on a wall surface of the intake port 26 can be suppressed.

Note that, when the SCV is fully closed and the first branch port part is completely blocked in order to strengthen the swirl flow, an inflow of intake air from the first branch port part to the combustion chamber is stopped. Strengthening of a swirl flow in the present application may also be realized by restricting the inflow of intake air from the first branch port part to the combustion chamber in a manner that stops the inflow of intake air from the first branch port part to the combustion chamber in this way. In this example, a flow of intake air does not arise within the first branch port part when a deviation is generated between the respective intake air flow rates. Accordingly, in this example, since intake air is more liable to stagnate inside the first branch port part, deposition of matter contained in the intake air can be more effectively suppressed by application of the configuration of the present embodiment.

Note that, in the above described first embodiment, the first LT cooling water channel 20 corresponds to “low-temperature cooling water channel” according to the present application, the LT cooling water circulation system 16 corresponds to “low-temperature cooling water circulation system” according to the present application, the HT cooling water channel 24 corresponds to “high-temperature cooling water channel” according to the present application, and the HT cooling water circulation system 18 corresponds to “high-temperature cooling water circulation system” according to the present application.

### Second Embodiment

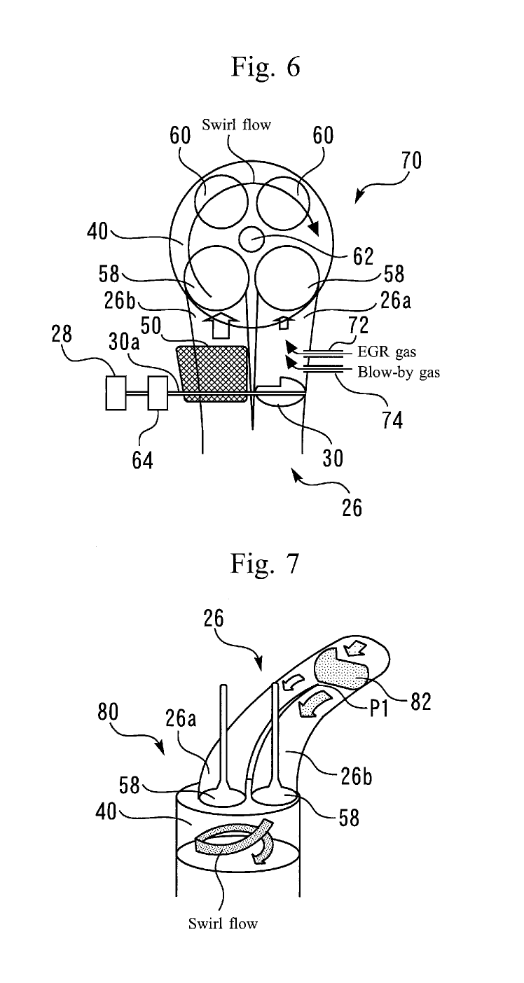

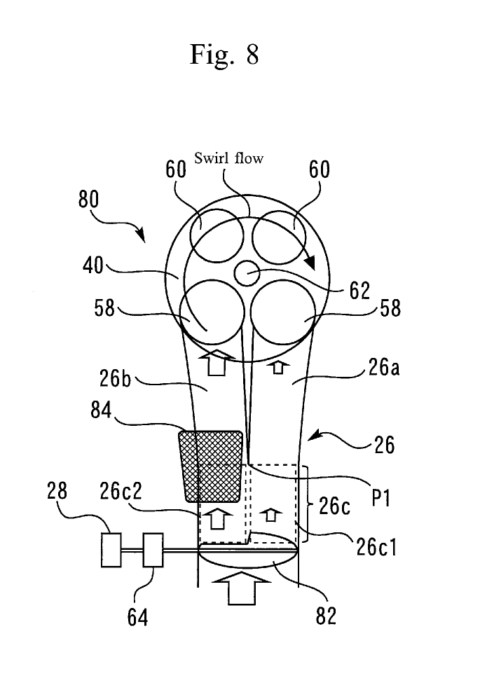

Next, a second embodiment of the present application will be described by newly referring to FIG. 6. An internal combustion engine 70 of the present embodiment has the same configuration as the engine 10 of the first embodiment with the exception that the configuration described hereunder referring to FIG. 6 is added to the engine 70 of the present embodiment. Note that the configuration of the present embodiment may also be implemented in combination with the configurations illustrated in FIG. 7 and FIG. 8 that are described later.

FIG. 6 is a schematic view for describing the configuration around the intake port 26 according to the second embodiment of the present application. In the engine 70 illustrated in FIG. 6, an exhaust gas recirculation (EGR) passage 72 and a blow-by gas return passage 74 are connected to the first branch port part 26a on the downstream side of the SCV 30. The EGR passage 72 is a passage through which recirculated exhaust gas (EGR gas) that returns to the intake passage from the exhaust passage flows. The blow-by gas return passage 74 is a passage for causing blow-by gas to return to the intake passage. Note that although the engine 70 in which both of the EGR passage 72 and the blow-by gas return passage 74 are connected to the first branch port part 26a has been described here, a configuration may also be adopted in which a passage connected to the first branch port part 26a is either one of the EGR passage 72 and the blow-by gas return passage 74.

The first branch port part 26a that is a part to which the EGR passage 72 and the blow-by gas return passage 74 are connected corresponds to a branch port part on the side on which the SCV 30 is provided, that is, a branch port part on the side that is not taken as an object of cooling because the side is not covered by the water jacket 50.

If the configuration is such that EGR gas or blow-by gas introduced into the intake passage flows through a region in which the wall surface is cooled, deposition of matter contained in the gas readily occurs on the cooled wall surface. The reason is that it is difficult for moisture or oil included in the EGR gas or blow-by gas to evaporate when adhered to the cooled passage wall surface.

In contrast, in the engine 70 of the present embodiment, as described above, the EGR passage 72 and the blow-by gas return passage 74 are connected to the first branch port part 26a on the side that is not taken as an object of cooling by the water jacket 50. By this means, the deposition on the wall surface of the intake port 26 due to introduction of EGR gas or blow-by gas can be suppressed in comparison to a configuration in which the first and second branch port part are equally cooled without giving particular consideration thereto.

Further, in the configuration of the present embodiment, the EGR passage 72 and the blow-by gas return passage 74 are connected to the first branch port part 26a on the downstream side of the SCV 30. By this means, when introducing EGR gas or blow-by gas under circumstances in which the SCV 30 is closed, the introduced EGR gas or blow-by gas can be prevented from flowing around to the side of the second branch port part 26b that is the other branch port part and being cooled by the water jacket 50.

### OTHER EMBODIMENTS

The foregoing first and second embodiments have been described taking a configuration in which the SCV 30 is arranged inside the first branch port part 26a as an example. However, a region in which the SCV that is an object of the present application is arranged may be a region described hereunder that is illustrated in FIG. 7. Further, in an example of an engine that includes the configuration illustrated in FIG. 7, a water jacket that cools some of the periphery of the intake port 26 may, for example, be a water jacket illustrated in FIG. 8.

FIG. 7 is a perspective view that schematically illustrates another configuration example of an SCV in the present application. An SCV 82 that an engine 80 shown in FIG. 7 includes is not arranged in the first branch port part 26a, but rather is arranged in the intake port 26 on the upstream side of a branch point P1 that is a point at which the first branch port part 26a and the second branch port part 26b branch. As shown in FIG. 7, in the SCV 82, a part on the side corresponding to the second branch port part 26b is notched. Consequently, when the SCV 82 is closed, an inflow of intake air from the first branch port part 26a to the combustion chamber 40 is restricted. As a result, in a case where the SCV 82 is provided, similarly to a case where the above described SCV 30 is provided, a deviation can be generated between the intake air flow rates of the first branch port part 26a and the second branch port part 26b.

FIG. 8 is a view for describing a region in which a water jacket 84 that covers a periphery of the intake port 26 in the engine 80 shown in FIG. 7 is arranged. A deviation between the intake air flow rates is also generated in a manner such that the intake air flow rate inside the first branch port part 26a becomes less than the intake air flow rate inside the second branch port part 26b by means of the SCV 82. Further, in the present configuration, a deviation between the intake air flow rates is also generated in a flow channel 26c in a section from the position of the SCV 82 to the branch point P1. Accordingly, the water jacket 84 is formed so as to cover the periphery of the intake port 26 on the downstream side of the SCV 82, which includes the second branch port part 26b, in the direction of the flow of intake air inside the intake port 26 (i.e. the extension direction of the intake port 26).

In a situation in which a deviation is generated between the intake air flow rates inside the intake port 26 by the SCV 82 (that is, the situation illustrated in FIG. 8), with regard to the flow channel 26c in the section from the position of the SCV 82 to the branch point P1, a region 26c1 that is located upstream of the first branch port part 26a corresponds to a region in which the intake air flow rate becomes relatively smaller, and a region 26c2 that is located upstream of the second branch port part 26b corresponds to a region in which the intake air flow rate becomes relatively larger. Further, under the above described circumstances, with regard to the branched intake port 26, the first branch port part 26a corresponds to a region in which the intake air flow rate becomes relatively smaller, and the second branch port part 26b corresponds to a region in which the intake air flow rate becomes relatively larger. Therefore, a region in which the water jacket 84 is arranged is defined as follows when the region is viewed at a cross-section that is perpendicular to the central trajectory of the intake port 26 (cross-section perpendicular to the extension direction of the intake port 26). That is, the water jacket 84 is formed so as to cover a part of the periphery of the second branch port part 26b and a part of the periphery of the aforementioned region 26c2 that corresponds to a region of the intake port 26 on the side on which the intake air flow rate becomes relatively larger in a situation in which the above described deviation is generated.

Note that, in the configuration shown in FIG. 8, the water jacket 84 is provided with respect to both of the second branch port part 26b and the region 26c2 located upstream of the second branch port part 26b. However, a region at which a water jacket is arranged in the engine 80 in which the SCV 82 is provided on the upstream side of the branch point P1 may also be either one of the second branch port part 26b and the region 26c2.

The foregoing first embodiment and the like are described taking the SCV 30 or SCV 82 as an example of a swirl control device. However, a swirl control device that is an object of the present application is not limited to a device that utilizes a swirl control valve, and for example may be the device described in the following. That is, a variable valve train is known which is configured so that a second intake valve that opens and closes a second branch port part can perform opening/closing actions while a first intake valve that opens and closes a first branch port part is maintained in a closed state. Strengthening of a swirl flow may be realized by stopping (restricting) an inflow of intake air to the combustion chamber from the first branch port part by using this kind of variable valve train. That is, even when the inflow of intake air is restricted by such a form, since stagnation of intake air may arise inside the first branch port part, the deposition of matter contained in intake air can be suppressed by application of the present application.

Further, in the above described first embodiment and the like, as shown in FIG. 1, the LT cooling water circulation system 16 through which LT cooling water of a relatively low temperature flows includes the first LT cooling water channel 20 that is formed inside the cylinder head 14, and the second LT cooling water channel 22 that is formed inside the cylinder block 12. However, a low-temperature cooling water channel of the low-temperature cooling water circulation system in the present application may be formed in only the cylinder head 14. Further, introduction of LT cooling water to the engine in the low-temperature cooling water circulation system may be performed in a manner in which the LT cooling water is not introduced into the cylinder head first, but rather is first introduced into the cylinder block.

Furthermore, in the above described first embodiment and the like, the intake port 26 in which a single first branch port part 26a and a single second branch port part 26b are connected to the common combustion chamber 40 is described as an example. However, in the present application, the number of first branch port parts that are connected to the common combustion chamber may be more than one, and similarly the number of second branch port parts connected to the common combustion chamber may also be more than one.

1. An internal combustion engine, comprising:
a low-temperature cooling water circulation system that is one of two cooling water circulation systems in which temperatures of cooling water are different, and that includes a low-temperature cooling water channel formed in an internal combustion engine, and that is configured to causes cooling water of a low temperature to circulate in the low-temperature cooling water channel;
a high-temperature cooling water circulation system that is one of the two cooling water circulation systems, and that includes a high-temperature cooling water channel formed in the internal combustion engine, and that configured to cause cooling water of a high temperature to circulate in the high-temperature cooling water channel;
an intake port including a first branch port part and a second branch port part that are connected to a common combustion chamber; and
a swirl control device configured to restrict an inflow of intake air from the first branch port part to the combustion chamber to increase a strength a swirl flow generated inside a cylinder,
wherein the low-temperature cooling water channel includes a water jacket that is arranged so as to cover a part of a periphery of the intake port when the intake port is viewed at a cross section that is perpendicular to a central trajectory of the intake port, and
wherein the water jacket is arranged so that, when the intake port is viewed at the cross section, the water jacket covers a periphery of a region in which an intake air flow rate inside the intake port becomes relatively larger when an inflow of intake air to the combustion chamber from the first branch port part is restricted by the swirl control device.

2. The internal combustion engine according to claim 1, further comprising an exhaust gas recirculation passage through which recirculated exhaust gas that returns from an exhaust passage to an intake passage flows,
wherein the swirl control device includes a swirl control valve that is configured to open and close an intake air flow channel inside the first branch port part, and
wherein the exhaust gas recirculation passage is connected to the first branch port part on a downstream side of the swirl control valve.

3. The internal combustion engine according to claim 1, further comprising a blow-by gas return passage through which blow-by gas that returns to an intake passage flows,
wherein the swirl control device includes a swirl control valve that is configured to open and close an intake air flow channel inside the first branch port part, and
wherein the blow-by gas return passage is connected to the first branch port part on a downstream side of the swirl control valve.

4. The internal combustion engine according to claim 1,
wherein the water jacket is formed so as to cover a periphery of the second branch port part.
